(19) United States
(12) Patent Application Publication
(10) Pub. No.: US 2011/0103835 A1
(43) Pub. Date: May 5, 2011

(54) DEVELOPING CARTRIDGE

(75) Inventors: Naoki Hayashi, Mishima-shi (JP); Tetsuya Numata, Suntou-gun (JP); Tetsushi Uneme, Susono-shi (JP); Yuuki Nakamura, Mishima-shi (JP)

(73) Assignee: CANON KABUSHIKI KAISHA, Tokyo (JP)

(21) Appl. No.: 12/913,220

(22) Filed: Oct. 27, 2010

(30) Foreign Application Priority Data
Oct. 30, 2009 (JP) 2009-250619
Oct. 30, 2009 (JP) 2009-250706

(51) Int. Cl. G03G 15/08; G03G 15/01

(52) U.S. Cl. 399/119; 399/227

(57) ABSTRACT

A developing cartridge detachably mountable to a main assembly of an image forming apparatus includes a frame; a developer carrying member, provided on the frame, for carrying a developer for developing an electrostatic image; a first portion to be engaged provided on one side of the frame with respect to a direction crossing an axial direction of the developer carrying member; a second portion to be engaged provided on the other side of the frame with respect to the direction crossing the axial direction of the developer carrying member; and a cover member, including a first engaging portion engaging with the first portion to be engaged and including a second engaging portion engaging with the second portion to be engaged, for covering an exposed portion of the developer carrying member by being detachably mounted to the frame. The cover member is detachably mountable to the frame by engaging the first engaging portion with second portion to be engaged and by engaging the second engaging portion with the first portion to be engaged.

### FIELD OF THE INVENTION AND RELATED ART

The present invention relates to a developing cartridge detachably mountable to an image forming apparatus of an electrophotographic type, such as a copying machine, a printer or a facsimile machine.

Here, the developing cartridge at least includes a developer carrying member for carrying and feeding a developer for developing an electrostatic latent image formed on an image bearing member which is an electrophotographic photosensitive member, and is detachably mountable to a main assembly of the image forming apparatus.

In the image forming apparatus, the electrostatic latent image formed on a drum-like electrophotographic photosensitive member as the image bearing member (hereinafter referred to as a photosensitive drum) is developed by a developing means, thus being visualized as a toner image.

In a conventional image forming apparatus using an electrophotographic image forming process, the developing cartridge as the developing means includes a toner accommodating portion for accommodating the developer (toner). Further, the developing cartridge is provided, in the toner accommodating portion, with the developer carrying member for developing the electrostatic latent image formed on the photosensitive drum (hereinafter referred to as a developing roller). These members are integrally assembled as the developing cartridge which is detachably mountable to a main assembly of the image forming apparatus.

The thus detachably mountable developing cartridge is exchanged by a user. At this time, the user dismounts the developing cartridge from the main assembly of the image forming apparatus and then mounts a fresh developing cartridge into the main assembly in general.

Here, to the fresh developing cartridge, a cover member for protecting the developing roller is attached. During the mounting of the developing cartridge in the main assembly, the user detaches the cover member from the developing cartridge and mounts the developing cartridge into the main assembly.

Further, the detached cover member is attached to the developing cartridge which has been used and dismounted from the main assembly of the image forming apparatus, so that the developing cartridge and the cover member can be collected simultaneously and recycled.

With respect to the cover member which is attached to the developing cartridge and is configured to protect the developing roller, a constitution disclosed in Japanese Laid-Open Patent Application (JP-A) 2003-173076 has been known.

When the detached cover member can be attached to the developing cartridge which has been used and dismounted from the image forming apparatus main assembly and can be collected for re-utilizing parts of the developing cartridge, limited resources can be effectively utilized.

Further, in the case where the developing cartridge is transported for reuse, damage on the surface of the developing roller exposed from the developing cartridge is required to be prevented. For this reason, it is desirably that the cover member, for covering the developing roller surface, which has been attached to the fresh developing cartridge is attached to the detached developing cartridge and then is sent back by the user.

The conventional cover member described above is capable of covering an entire exposed area of the developing roller exposed from the developing cartridge and is capable of being detached from the developing cartridge. Further, a plurality of engaging portions between the developing cartridge and the cover member is provided at end portions of the developing roller with respect to an axial direction (i.e., a longitudinal direction) of the developing roller or at portions along the longitudinal direction of the developing roller. For this reason, when the user attach the cover member to the developing cartridge after use, the user is required to properly engage the engaging portions in a state which is the exactly same as the state in which the cover member has been attached to the fresh developing cartridge. For that reason, there was a possibility that the user was unable to attach the cover member to the developing cartridge easily.

### SUMMARY OF THE INVENTION

A principal object of the present invention is to provide a developing cartridge, to which a cover member is attached, having good usability.

According to an aspect of the present invention, there is provided a developing cartridge detachably mountable to a main assembly of an image forming apparatus, the developing cartridge comprising:

a frame;

a developer carrying member, provided on the frame, for carrying a developer for developing an electrostatic image;

a first portion to be engaged provided on one side of the frame with respect to a direction crossing an axial direction of the developer carrying member;

a second portion to be engaged provided on the other side of the frame with respect to the direction crossing the axial direction of the developer carrying member; and

a cover member, including a first engaging portion engaging with the first portion to be engaged and including a second engaging portion engaging with the second portion to be engaged, for covering an exposed portion of the developer carrying member by being detachably mounted to the frame,

wherein the cover member is detachably mountable to the frame by engaging the first engaging portion with second portion to be engaged and by engaging the second engaging portion with the first portion to be engaged.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of an example of an image forming apparatus to which a developing cartridge according to the present invention is detachably mountable.

FIG. 2 is a perspective view of an outer appearance of an embodiment of the developing cartridge of the present invention.

FIG. 3 is a schematic view of the image forming apparatus shown in FIG. 1 during image formation.

FIGS. 4(a) and 4(b) are schematic sectional views of the developing cartridge of the present invention, in which FIG. 4(a) shows a state in which a cover member is mounted and FIG. 4(b) shows a state in which the cover member is removed.

FIGS. 5(a) and 5(b) are schematic perspective views, in which FIG. 5(a) shows a developing roller and FIG. 5(b) illustrating a manner in which the developing roller is mounted to the developing cartridge.

FIGS. 6(a), 6(b) and 6(c) are schematic perspective views, in which FIG. 6(a) shows the developing cartridge of the present invention and the cover member, FIG. 6(b) shows a state in which the cover member is removed from the developing cartridge, and FIG. 6(c) shows the removed cover member.

FIG. 7 is a schematic sectional view showing the developing cartridge of the present invention in a state in which the cover member is attached.

FIG. 8(a) is a perspective view showing a state in which developing cartridges of the present invention are mounted in a rotary, and FIG. 8(b) is a partial sectional view of the rotary.

FIG. 9(a) is a schematic sectional view showing a state in which the cover member is attached to the developing cartridge of the present invention in a 180-degree turn state, and FIG. 9(b) is a perspective view of the developing cartridge.

FIG. 10 is a schematic sectional view of the developing cartridge placed on a table in a state in which the cover member is attached to the developing cartridge.

FIGS. 11(a) and 11(b) are schematic sectional views each for illustrating a manner of attaching the cover member to the developing cartridge of the present invention.

FIG. 12 is a schematic sectional view for illustrating a gripping method when the cover member is attached to the developing cartridge of the present invention.

FIG. 13 is a schematic sectional view for illustrating a gripping method when the cover member is attached to the developing cartridge of the present invention.

FIG. 14 is a perspective view showing the developing cartridge of the present invention and a grip portion of the cover member.

### DESCRIPTION OF THE PREFERRED EMBODIMENTS

Hereinbelow, the developing cartridge according to the present invention will be described in detail with reference to the drawings.

### Embodiment 1

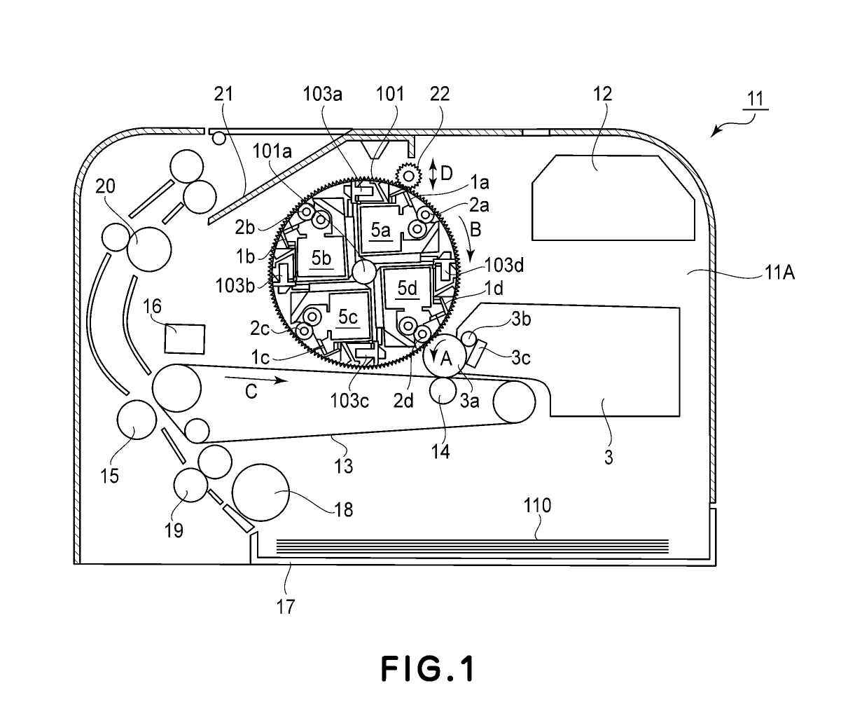

FIG. 1 shows an embodiment of a so-called rotary type color electrophotographic image forming apparatus including a rotary in which a plurality of developing cartridges is mountable.

### (General Structure of Image Forming Apparatus)

First, a general structure and an image forming operation of the image forming apparatus will be described with reference to FIG. 1.

An image forming apparatus 11 in this embodiment is a four color-based full-color laser beam printer. FIG. 1 is a sectional view showing a schematic structure of the image forming apparatus 11.

As shown in FIG. 1, the image forming apparatus 11 includes a drum-like electrophotographic photosensitive member as an image bearing member, i.e., a photosensitive drum 3a. At a periphery of the photosensitive drum 3a, a charging means 3b for uniformly charging the photosensitive drum 3a and an exposure means 12 for forming a latent image on the photosensitive drum 3a by irradiating the surface of the photosensitive drum 3a with laser light are disposed. Further, as a developing means, a plurality of developing cartridges 5 (5a to 5d) each for developing the latent image formed on the photosensitive drum 3a with a developer (toner) of an associated color is disposed adjacently to the photosensitive drum. In this embodiment, the plurality of developing cartridges 5 include to a yellow developing device 5a, a magenta developing device 5b, a cyan developing device 5c and a black developing device 5d. Further, at the periphery of the photosensitive drum 3a, a cleaning means 3c for removing residual toner on the photosensitive drum 3a is disposed.

In this embodiment, the photosensitive drum 2a, the charging means 2b and the cleaning means 2c are integrally constituted and are assembled into a drum cartridge 2, which is detachably mountable to the image forming apparatus main assembly 11A and is employed.

The yellow developing cartridge 5a, the magenta developing cartridge 5b, the cyan developing cartridge 5c and the black developing cartridge 5d include developer carrying members, i.e., developing rollers 2 (2a, 2b, 2c and 2d), respectively. The developing cartridges 5 (5a, 5b, 5c and 5d) are held by a rotary 101 rotatably mounted in the apparatus main assembly 1.

The rotary 101 has the same holding constitution with respect to all of the yellow developing cartridge 5a, the magenta developing cartridge 5b, the cyan developing cartridge 5c and the black developing cartridge 5d. Therefore, in this embodiment, the developing cartridge holding constitution of the rotary 101 will be described with respect to the yellow developing cartridge 5a.

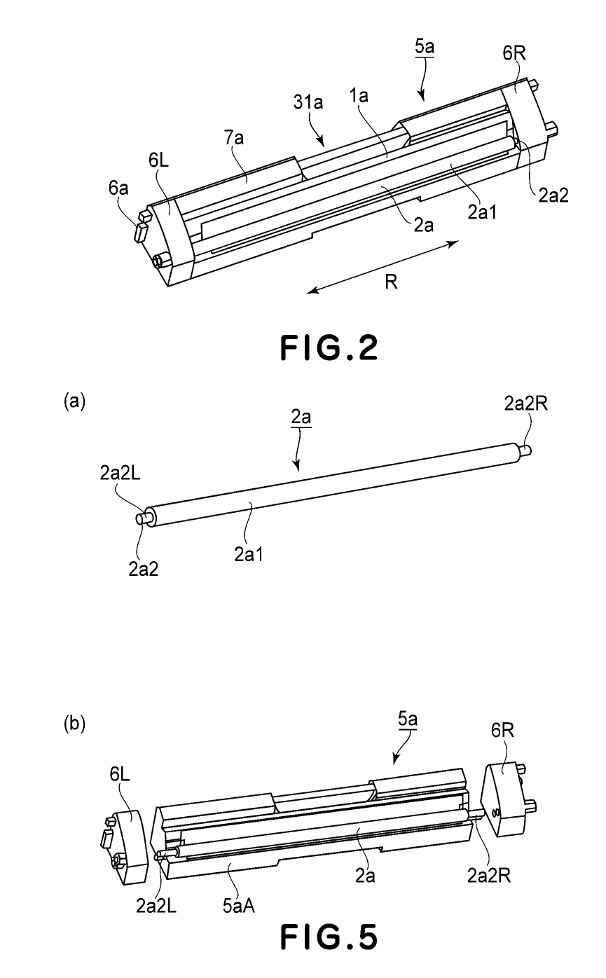

When the yellow developing cartridges 5a is mounted in the rotary 101, portion to be locked 6a (FIG. 2) engages with a developing cartridge locking member 103a (FIG. 1) provided in the rotary 101. As a result, the yellow developing cartridge 5a is supported by the rotary 101. The developing cartridge locking member 103a engages with the yellow developing cartridge 5a by a spring (not shown) to prevent movement of the rotary 101 in a direction indicated by an arrow D in FIG. 1.

In the same manner as in the case of the yellow developing cartridge 5a, the magenta developing cartridge 5d, the cyan developing cartridge 5c and the black developing cartridge 5d are similarly supported.

An operation of image formation will be described below.

First, the photosensitive drum 3a is rotated in a direction indicated by an arrow A in FIG. 1. In synchronism with rotation of the photosensitive drum 3a, an intermediary transfer belt 13 in a direction indicated by an arrow C in FIG. 1. Then, the surface of the photosensitive drum 3a is uniformly charged by the charging means 3b and at the same time is irradiated with light for a yellow image by the exposure means 12, so that an electrostatic latent image for yellow is formed on the photosensitive drum 3a.

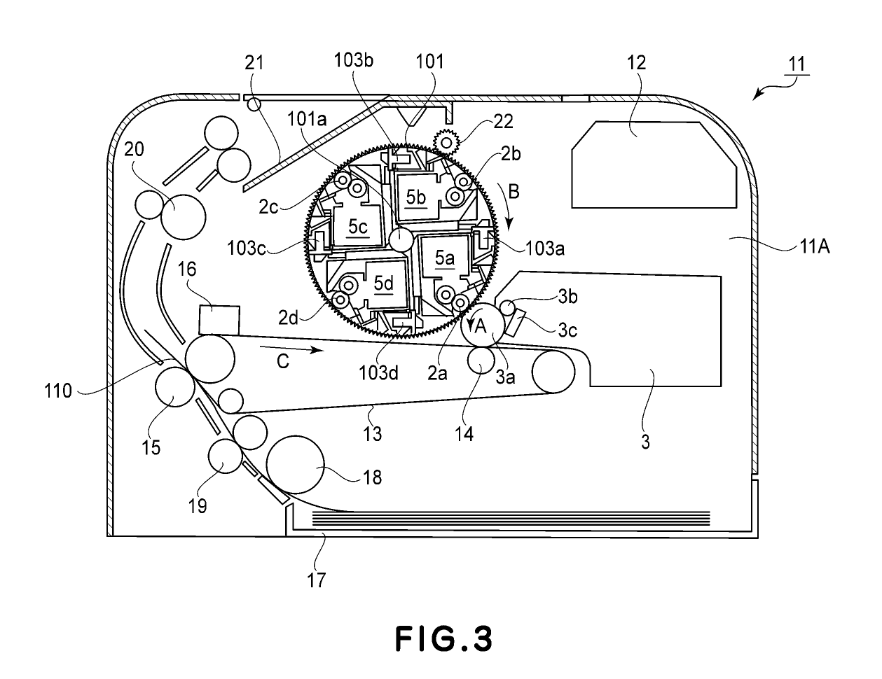

In synchronism with this formation of the electrostatic latent image, the rotary 101 which holds the developing cartridges 5 (5a to 5d) and is rotatably is rotated about a rotary rotational axis (rotation shaft) 101a in the direction indicated by an arrow B in FIG. 1 by a drive transmission mechanism 22 provided in the image forming apparatus 11. By the rotation of the rotary 101, the yellow developing cartridge 5a is disposed at a developing position in which the yellow developing cartridge 5a opposes the photosensitive drum 3a as shown in FIG. 3.

Then, a potential difference is provided between of the photosensitive drum 3a and a developing roller 2a so that a yellow developer is deposited on the latent image formed on the photosensitive drum 3a. As a result, the latent image formed on the photosensitive drum 3a is developed by depositing the yellow developer thereon. That is, a yellow toner image is formed on the photosensitive drum 3a.

Thereafter, by applying a voltage of an opposite polarity to the toner charge polarity to a primary transfer roller 14 disposed inside the intermediary transfer belt 13, the yellow toner image is primary-transferred from the photosensitive drum 3a on to the intermediary transfer belt 13.

In the above-described manner, when the primary transfer of the yellow toner image is completed, the rotary 101 is rotationally moved in the arrow B direction in FIG. 3 by receiving a driving force from the drive transmission mechanism 22 of the image forming apparatus 11. Then, the magenta developing cartridge 5b, the cyan developing cartridge 5c and the black developing cartridge 5d are successively positioned at the developing position in which the positioned developing cartridge opposes the photosensitive drum 3a.

Similarly as in the case of yellow, with respect to each of the colors of magenta, cyan and black, the formation of the electrostatic latent image, the development of the electrostatic latent image and the primary transfer are successively performed, so that four color toner images are superposed on the intermediary transfer belt 13.

During this image forming operation, as shown in FIG. 1(a), a secondary transfer roller 15 is in non-contact with the intermediary transfer belt 13. Further, at that time, a cleaning unit 16 for the intermediary transfer belt 13 is also in non-contact with the intermediary transfer belt 13.

On the other hand, sheets 110 which are a material (medium) onto which the toner images are transferred, i.e., a recording material are stacked and accommodated in a sheet feeding cassette 17 provided at a lower portion of the image forming apparatus 11 and are separated and fed one by one from the sheet feeding cassette 17 by a sheet feeding roller 18, thus being fed to conveying rollers 19. The conveying rollers 19 send the fed sheet S between the intermediary transfer belt 13 and the secondary transfer roller 15. Here, as shown in FIG. 3, the secondary transfer roller 15 is in a state in which it press-contacts the intermediary transfer belt 13.

Further, the voltage of the opposite polarity to the toner charge polarity has been applied to the secondary transfer roller 15, so that the above-described four color toner images superposed on the intermediary transfer belt 13 are collectively secondary-transferred onto the surface of the conveyed sheet 110.

The sheet 110 on which the toner images are transferred is sent to a fixing device 20. In the fixing device 20, the sheet 110 is subjected to heat and pressure, so that the toner images are fixed on the sheet 110. Thereafter, the sheet 110 is discharged from the fixing device 20 to a sheet discharge portion 21 outside the image forming apparatus 11.

### (Developing Cartridge)

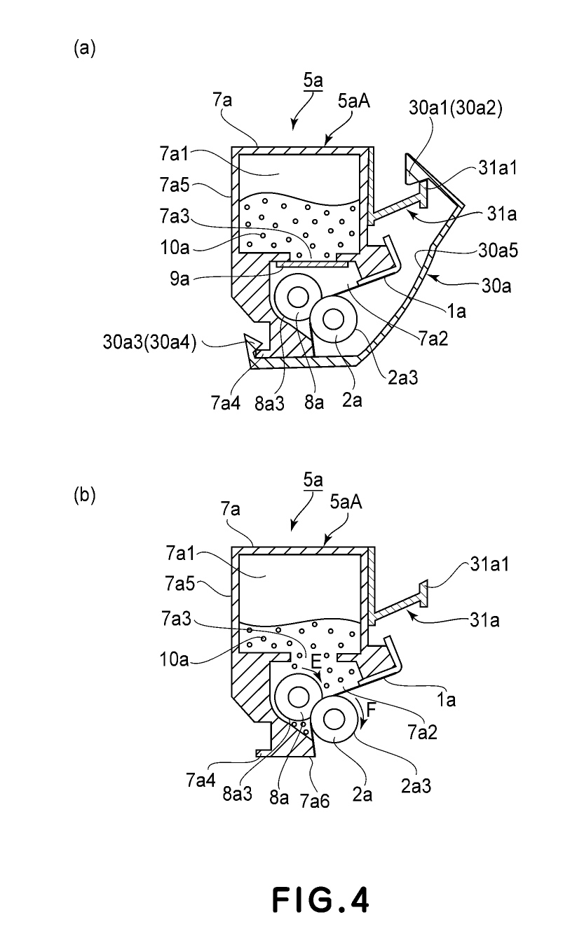

With respect to the developing cartridges 5, all the constitutions of the yellow developing cartridge 5a, the magenta developing cartridge 5b, the cyan developing cartridge 5c and the black developing cartridge 5d are the same. Therefore, the description of the constitutions of the respective developing cartridges will be made with respect to the yellow developing cartridge 5a. The yellow developing cartridge 5a in this embodiment will be described with reference to FIGS. 4(a), 4(b), 5(a) and 5(b).

FIGS. 4(a) and 4(b) are sectional views of the yellow developing cartridge 5a as seen in a direction perpendicular to the longitudinal direction of the yellow developing cartridge 5a, i.e., the longitudinal direction passing through a grip portion 31a provided on the yellow developing cartridge 5a in the neighborhood of a central portion with respect to the axial direction of the yellow developing cartridge 5a.

The yellow developing cartridge 5a includes a developing cartridge frame 5aA. The developing cartridge frame 5aA constitutes a developer container 7a as a toner accommodating portion for accommodating the developer (toner) and rotatably holds the developing roller 2a or the like for carrying and feeding the toner, thus integrally assembling these members into a unit. The developer container 7a of the yellow developing cartridge 5a is separated into a toner accommodating chamber 7a1 and a developing chamber 7a2 including the developing roller 2a and a toner feeding roller 8a. These chambers 7a1 and 7a2 are connected by a toner feeding opening 7a3.

A developing roller outer surface 2a3 of the developing roller 2a and a toner feeding roller outer surface 8a3 of the toner feeding roller 8a are disposed so as to contact each other in the developing chamber 7a2.

The developing roller 2a is, as shown in FIG. 5(a), constituted by a rubber roller portion 2a1 and a rigid member shaft 2a2. The rigid member shaft 2a2 penetrates through the rubber roller portion 2a1 with respect to a rotational axis direction of the developing roller 2a, so that protruded portions 2a2L and 2a2R protruded from the rubber roller portion 2a1 at both end portions of the portion 2a1.

A constitution in which the developing roller 2a of the yellow developing cartridge 5a is rotatably supported by the frame 5aA will be described with reference to FIG. 5(b).

In this embodiment, the yellow developing cartridge 5a rotatably holds the developing roller 2a by side members 6L and 6R which are provided on both sides of the frame 5aA and hold the protruded portions 2a2L and 2a2R of the developing roller 2a.

Further, in this embodiment, in an unused state until the yellow developing cartridge 5a is delivered to the user, as shown in FIG. 4(a), at the toner feeding opening 7a3, a film-like toner seal 9a is fixed to the developing container 7 by welding.

Further, as is understood from FIG. 4(b), a part of the rubber roller outer surface 2a3 of the developing roller 2a is exposed from the yellow developing cartridge 5a, so that the user can directly touch the exposed portion with hand. For that reason, as shown in FIG. 5(a), in the unused state, a cover member 30a for covering the entire exposed portion of the rubber roller outer surface 2a3 is provided. By detaching this cover member 30a, the rubber roller outer surface 2a3 is exposed and contacts the photosensitive drum 3a in the image forming apparatus 11 as shown in FIG. 3.

In FIG. 4(b), toner 10a in the developing chamber 7a2 is fed to the toner feeding roller 8a, which is rotated in a direction indicated by an arrow Z in FIG. 4(b) to feed the toner 10a to the developing roller 2a. The developing roller 2a is rotated in a direction indicated by an arrow F in FIG. 4(b), so that the toner 10a on the developing roller 2a is regulated by a developing blade 1a. Then, at a position in which the developing roller 2a opposes the photosensitive drum 3a, the toner 10a is subjected to development. Thereafter, the toner 10a left on the developing roller 2a is removed by and fed to the toner feeding roller 8a. To the developing roller 2a, a voltage is supplied from the image forming apparatus 11 so as to provide the potential difference between itself and the photosensitive drum 3a. Also to the toner feeding roller 8a, the voltage is supplied from the image forming apparatus 11.

### (Engagement Between Cover Member and Developing Cartridge)

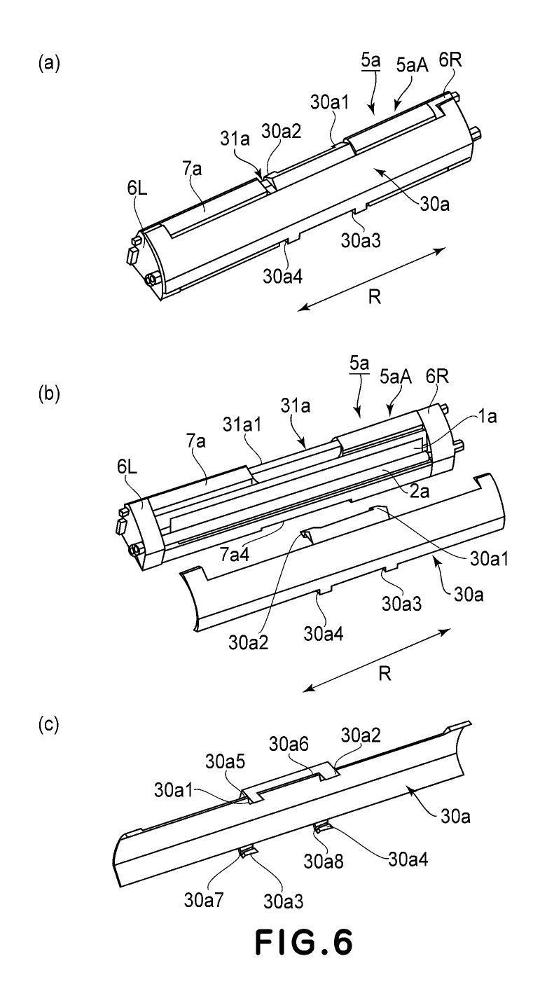

A constitution of the engagement between the cover member and the developing cartridge will be described with reference to FIGS. 6(a), 6(b), 7, 8(a) and 8(b). The engaging constitution between the cover member and the developing cartridge is similarly employed also with respect to other developing cartridges, i.e., the magenta developing cartridge 5b, the cyan developing cartridge 5c and the black developing cartridge 5d. Therefore, the description of the engaging constitution between the cover member and the developing cartridge will be made with respect to the yellow developing cartridge 5a and the cover member 30a to be attached to the yellow developing cartridge 5a.

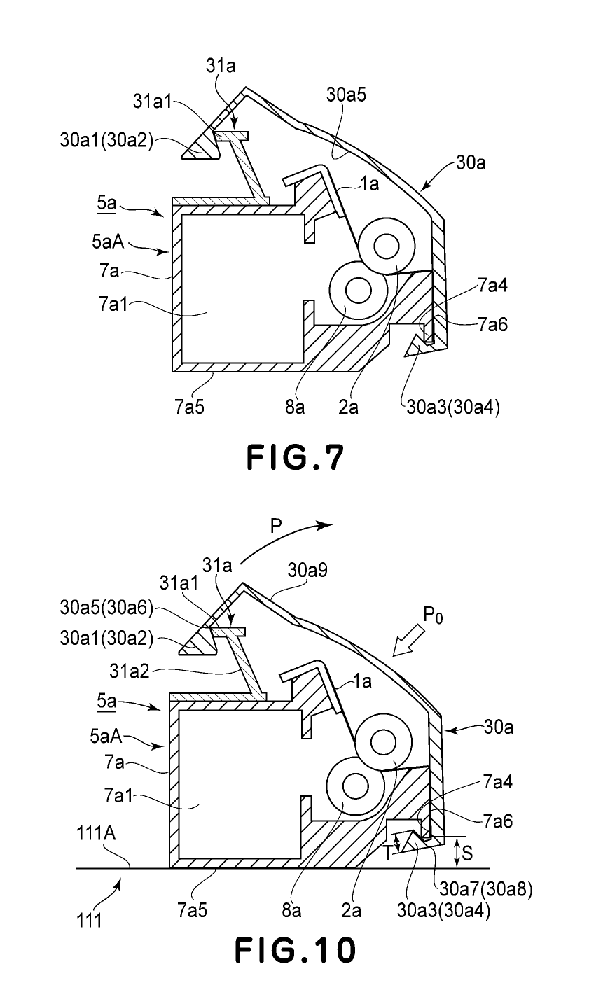

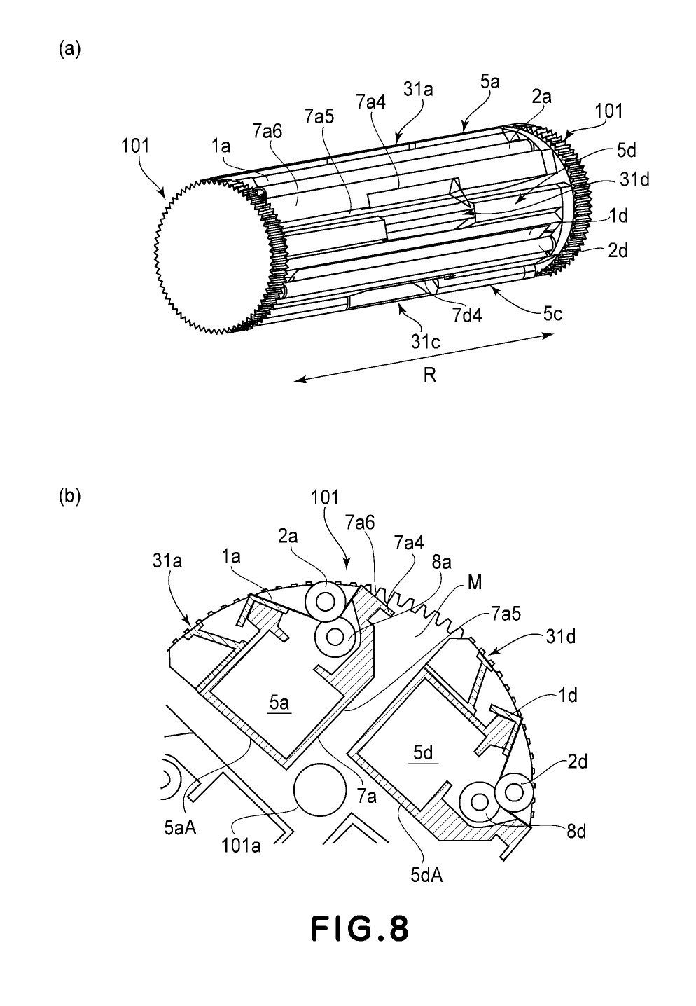

FIG. 6(a) is a perspective view showing a state in which the cover member 30a is attached to the yellow developing cartridge 5a. FIG. 6(b) is a perspective view showing a state in which the cover member 30a is detached from the yellow developing cartridge 5a. FIG. 7 is a sectional view of the developing cartridge 5a as seen in a direction perpendicular to the longitudinal direction (indicated by an arrow R in FIG. 6(a)) along the grip portion 31a provided in the neighborhood of the central portion of the yellow developing cartridge 5a. FIG. 8(a) is a perspective view showing a state in which the developing cartridges 5 are mounted in the rotary 101. FIG. 8(b) is a schematic sectional view showing the state in which the developing cartridges 5 are mounted in the rotary 101.

The yellow developing cartridge 5a engages with the cover member 30a at two portions including a grip-side portion to be engaged (first portion to be engaged) 31a1 provided on the grip portion 31a in the neighborhood of the longitudinal central portion and a container-side portion to be engaged (second portion to be engaged) 7a4 provided on the developing container 7a as shown in FIGS. 6(b) and 7.

Here, the container-side portion to be engaged 7a4 is, as shown in FIGS. 8(a) and 8(b), disposed at a position in which it opposes a grip portion 31d of the black developing cartridge 5d adjacent to the yellow developing cartridge 5a mounted in the rotary 101. That is, the container-side portion to be engaged 7a4 is positioned in the neighborhood of the longitudinal central portion of the yellow developing cartridge 5a and is provided at a position in which surface 7a5 and 7a6 of the developing container 7a are cut away.

This is because, as shown in FIG. 8(b), in a state in which the plurality of the developing cartridges 5 is mounted in the apparatus main assembly 11A, operativity of the adjacent black developing cartridge 5d can be improved. That is, in the case where the grip portion 31d is gripped in order to operate the black developing cartridge 5d, a space M is provided in order to improve a gripping property by separating the adjacent container-side portion to be engaged 7a4 from the grip portion 31d. In this embodiment, the constitution described above is employed in view of usability for the rotary type image forming apparatus.

Next, the cover member 30a will be described.

As shown in FIGS. 6(b) and 7, the cover member 30a engages with the yellow developing cartridge 5a at four engaging portions 30a1, 30a2, 30a3 and 30a4 provided in the neighborhood of the longitudinal central portion.

That is, the yellow developing cartridge 5a is provided with the grip portion-side portion to be engaged 31a1 on one end side of the frame 5aA and with the container-side portion to be engaged 7a4 or the other end side with respect to a direction crossing the longitudinal direction (i.e., the AD) of the developing roller 2a. Further, the engaging portions provided on the cover member 30a, i.e., the first engaging portions 30a1 and 30a2 of the cover member 30a engage with the grip portion-side portion to be engaged 31a1, and the second engaging portions 30a3 and 20a4 engage with the container-side portion to be engaged 7a4 of the developing container 7a, at the same time. As a result, the cover member 30a is applied to the developing cartridge 5a (FIG. 6(a)). At this time, the surface 30a5 of the cover member 30a does not contact the developing roller 2a.

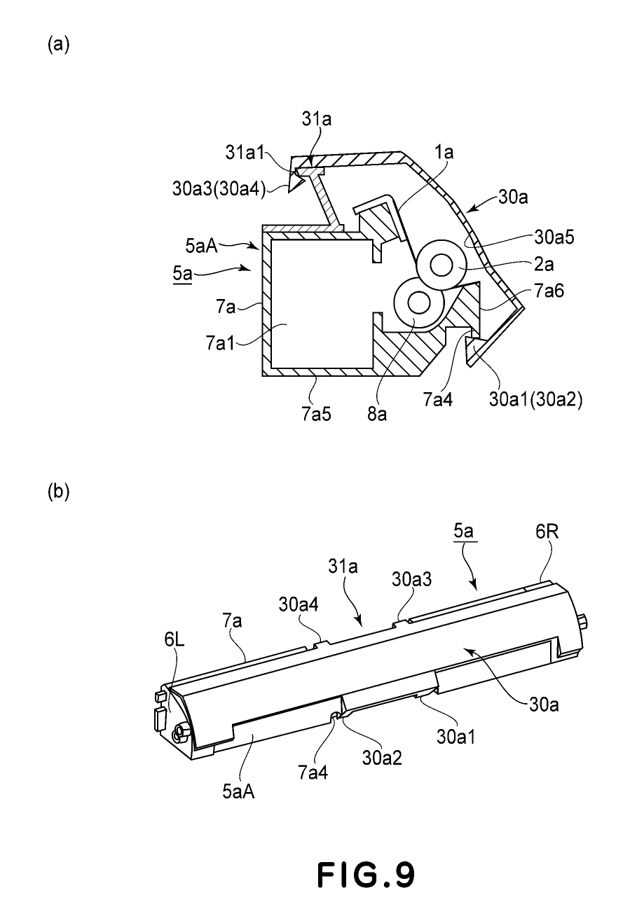

Further, the cover member 30a engages with the developing cartridge 5a at the portions to be engaged associated with the engaging portions described above but as shown in FIGS. 9(a) and 9(b), the engaging portions 30a1 and 30a2 can engage with the container-side portion to be engaged 7a4 and the engaging portions 30a3 and 30a4 can engage with the grip portion-side portion to be engaged 31a1, at the same time. That is, the cover member 30a can also be applied to the yellow developing cartridge 5a even in a 180-degree turn state of the cover member 30a.

That is, according to the present invention, the cover member 30a can be placed in a first state in which the first engaging portions 30a1 and 30a2 engage with the first portion to be engaged 31a1 and the second engaging portions 30a3 and 30a4 engage with the second portion to be engaged 7a4 to attach the cover member 30a to the frame 5aA. On the other hand, the cover member 30a can also be placed in a second state in which the first engaging portions 30a1 and 30a2 engage with the second portion to be engaged 7a4 and the second engaging portions 30a3 and 30a4 engage with the first portion to be engaged 31a1 to attach the cover member 30a to the frame 5aA.

This is because the grip portion-side portion to be engaged (first portion to be engaged) 31a1 and the developing container-side portion to be engaged (second portion to be engaged) 7a4 for forming the space M for improving the gripping property of the grip portion 31 in the image forming apparatus 11 are disposed at the same position with respect to the longitudinal direction. Further, even in the case where the cover member 30a is attached to the yellow developing cartridge 5a in the 180-degree turn state, the surface 30a5 of the cover member 30a is configured so as not to contact the developing roller 2a. Therefore, irrespective of the attaching direction of the cover member 30a, it is possible to protect the entire developing roller area exposed from the developing container 7a, i.e., the frame 5aA.

As described above, the developing cartridge 5 in this embodiment includes the grip portion-side portion to be engaged 31a1 and the container-side portion to be engaged 7a4 which are disposed in the neighborhood of the longitudinal central portion of the developing cartridge 5. As a result, the cover member 30a is configured to be attached to the developing cartridge 5 by engaging the engaging portions 30a1, 30a2, 30a3 and 30a4 with the portions to be engaged 31a1 and 7a4 at the same time, irrespective of the direction of the cover member 30a.

Therefore, when the user stores and sends back the developing cartridge 5 after use, the cover member 30a can be attached to the developing cartridge 5 easily. For that reason, the entire developing roller area exposed from the developing cartridge 5 can be protected, so that it is possible to compatibly realize the usability and easy recycling property of parts of the developing cartridge 5.

In this embodiment, the yellow developing cartridge 5a is described but the above description is also true for other developing cartridges 5b for magenta, 5c for cyan, and 5d for black.

Further, in this embodiment, the case of the color developing cartridges used in the rotary type electrophotographic image forming apparatus is described but the present invention is not limited thereto. For example, the present invention is also applicable to the developing cartridges or a monochromatic developing cartridge in the case of an in-line type image forming apparatus.

### Embodiment 2

### (Mounting and Dismounting Constitution of Cover Member)

The mounting and dismounting constitution of the cover member and the developing cartridge is the same with respect to all the developing cartridges, i.e., the yellow developing cartridge 5a, the magenta developing cartridge 5b, the cyan developing cartridge 5c and the black developing cartridge 5d. Therefore, the description of the mounting and dismounting constitution of the cover member in this embodiment will be made with respect to the yellow developing cartridge 5a.

FIG. 6(a) shows a state in which the cover member 30a is mounted on (attached to) the yellow developing cartridge 5a. FIG. 6(b) shows a state in which the cover member 30a is dismounted (detached) from the yellow developing cartridge 5a. FIG. 6(c) shows a state in which the cover member 30a is viewed from the inside thereof. FIG. 10 is a sectional view of the developing cartridge 5a as seen in a direction perpendicular to the longitudinal direction (i.e., the axial direction R in FIG. 6(b)) along the grip portion 31a provided in the neighborhood of the central portion of the yellow developing cartridge 5a.

In this embodiment, the yellow developing cartridge 5a is, as shown in FIGS. 6(b) and 10, provided with the grip portion 31a on one end side of the frame 5aA with respect to the direction crossing the longitudinal direction in the neighborhood of the longitudinal central portion and is provided with the grip portion-side portion to be engaged (first portion to be engaged) 31a1 on the grip portion 31a. On the other end side of the frame 5aA opposite from the side where the grip portion 31a is provided, the container-side portion to be engaged (second portion to be engaged) 7a4 is provided in the neighborhood of the longitudinal central portion while interposing the developing roller 2a between the portions 31a1 and 7a4. The yellow developing cartridge 5a engages with the cover member 30a at these two portions, i.e., the grip portion-side portion to be engaged 31a1 provided on the grip portion 31a and the container-side portion to be engaged 7a4 provided on the opposite side to the grip portion 31a side.

On the other hand, the cover member 30a includes, as shown in FIGS. 6(C) and 10, the four engaging portions 30a1, 30a2, 30a3 and 30a4 provided in the neighborhood of the longitudinal central portion. Further, the cover member 30a is attached to the yellow developing cartridge 5a by engaging the engaging portions (first engaging portions) 30a1 and 30a2 with the grip portion-side portion to be engaged 31a1 and by engaging the engaging portions (second engaging portions) 30a3 and 30a4 with the container-side portion to be engaged 7a4.

At this time, the two portions to be engaged, i.e., the grip portion-side portion to be engaged (first portion to be engaged) 31a1 and the container-side portion to be engaged (second portion to be engaged) 7a4 at least overlap with each other with respect to a direction perpendicular to the axial direction of the developing roller 2a. As a result, the cover member 30a can be easily attached to the frame 5aA by pushing a portion between the first engaging portion 30a1 (30a2) and the second engaging portion 30a3 (30a4) with respect to a direction indicated by an arrow P₀ in FIG. 10. FIG. 8(a) is a perspective view showing a state in which the developing cartridges 5 are mounted in the rotary 101. FIG. 8(b) is a schematic sectional view showing the state in which the developing cartridges 5 are mounted in the rotary 101.

The yellow developing cartridge 5a engages with the cover member 30a at two portions including a grip-side portion to be engaged 31a1 provided on the grip portion 31a in the neighborhood of the longitudinal central portion and a container-side portion to be engaged 7a4 provided on the developing container 7a as shown in FIGS. 6(b) and 10.

Here, the container-side portion to be engaged 7a4 is, as shown in FIGS. 8(a) and 8(b), disposed at a position in which it opposes a grip portion 31d of the black developing cartridge 5d adjacent to the yellow developing cartridge 5a mounted in the rotary 101. That is, the container-side portion to be engaged 7a4 is positioned in the neighborhood of the longitudinal central portion of the yellow developing cartridge 5a and is provided at a position in which surface 7a5 and 7a6 of the developing container 7a are cut away.

This is because, as shown in FIG. 8(b), in a state in which the plurality of the developing cartridges 5 is mounted in the apparatus main assembly 11A, operativity of the adjacent black developing cartridge 5d can be improved. That is, in the case where the grip portion 31d is gripped in order to operate the black developing cartridge 5d, a space M is provided in order to improve a gripping property by separating the adjacent container-side portion to be engaged 7a4 from the grip portion 31d. In this embodiment, the constitution described above is employed in view of usability for the rotary type image forming apparatus.

Here, as described above, the yellow developing cartridge 5a in the unused state is required that a toner seal 9a is removed and the cover member 30a is detached before use. In this embodiment, this operation before the use of the yellow developing cartridge 5a may preferably be performed in a state in which the yellow developing cartridge 5a is placed on a table (stage) 111 such as a horizontal table as shown in FIG. 10. FIG. 10 shows an attitude such that the yellow developing cartridge 5a is mounted on the table 111 so that a disposing surface 7a5 of the yellow developing cartridge 5a contacts a mounting surface 111A of the table 111. In this attitude, the grip portion 31a of the yellow developing cartridge 5a is most distant from the table 111. That is, the yellow developing cartridge 5a is mounted on the mounting surface 111A of the table 111 so that the grip portion-side portion to be engaged (first portion to be engaged) 31a1 is positioned above the container-side portion to be engaged (second portion to be engaged) 7a4.

In this attitude, the user grips the grip portion 31a and performs an operation for raising the yellow developing cartridge 5a from the table 111 or an operation for placing the yellow developing cartridge 5a on the table 111. Further, the grip portion 31a is provided with the portion to be engaged 31a1 for the cover member 30a, so that the mounting and dismounting operation of the cover member 30a with respect to the yellow developing cartridge 5a can also be performed by the operation of the grip portion 31a. Thus, the grip portion 31a has the functions of operating the yellow developing cartridge 5a and effecting the mounting and dismounting operation of the cover member 30a, so that the cover member 30a can be operated easily.

A constitution in which the cover member 30a is detached from the yellow developing cartridge 5a in the attitude described above will be described with reference to FIG. 10.

First, the cover member 30a is moved in a direction indicated by an arrow P with the container-side portion to be engaged 7a4 as the rotational movement center. At this time, engaging portion base portions 30a5 and 30a6 at the engaging portions 30a1 and 30a2 engaged with the grip portion-side portion to be engaged 31a1 are bent to release the engagement with the grip portion-side portion to be engaged 31a1. After the engagement of the engaging portions 30a1 and 30a2 with the grip portion-side portion to be engaged 31a1, the cover member 30a is rotationally moved about the engaging portions 30a2 and 30a4, so that the cover member 30a can be dismounted from the yellow developing cartridge 5a.

Next, by dismounting the engaging portions 30a3 and 30a4 from the container-side portion to be engaged 7a4, the cover member 30a can be detached from the yellow developing cartridge 5a. At this time, a height H of a claw portion of the engaging portions 30a3 and 30a4 is made smaller than a distance S between an end of the container-side portion to be engaged 7a4 and the disposing surface 7a5 of the developing container 7a. As a result, during the dismounting of the cover member 30a, the engaging portions 30a3 and 30a4 are prevented from interfering with the table 111 and the end of the container-side portion to be engaged 7a4.

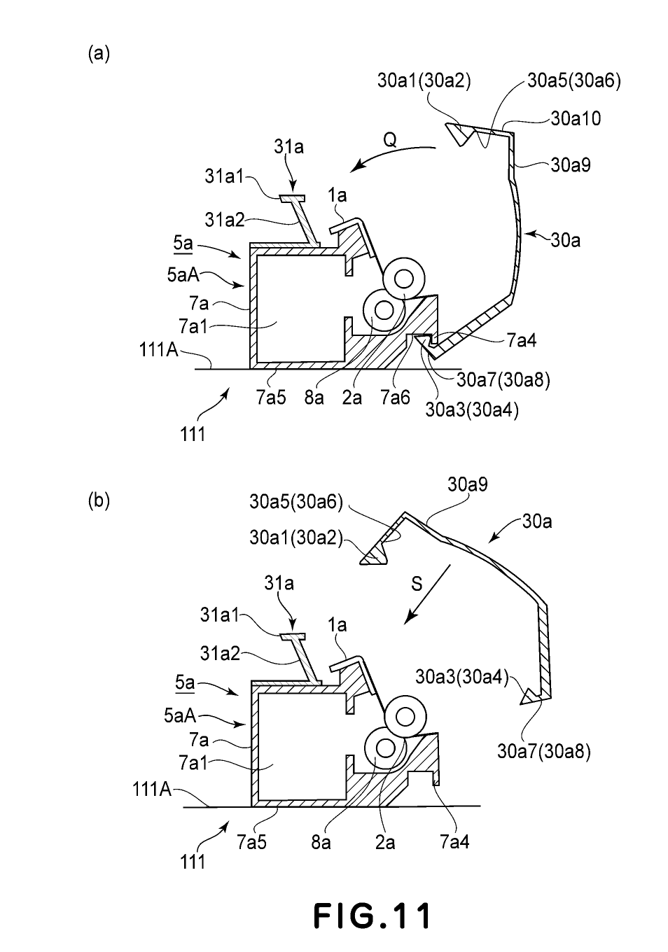

Further, a constitution in which the cover member 30a is attached to the yellow developing cartridge 5a is shown in FIG. 11(a).

Similarly as in the case of detaching the cover member 30a, the yellow developing cartridge 5a is placed on the table 111 so that its disposing surface 7a5 contacts the mounting surface 111A of the table 111. That is, the yellow developing cartridge 5a is placed on the mounting surface 111A of the table 111 so that the grip portion-side portion to be engaged 31a1 is positioned above the container-side portion to be engaged 7a4.

Then, the engaging portions 30a3 and 30a4 are engaged with the container-side portion to be engaged 7a4 and the cover member 30a is rotationally moved in a direction indicated by an arrow Q in FIG. 11(a) with the container-side portion to be engaged 7a4 as the rotational movement center. Then, the engaging portion base portions 30a5 and 30a6 of the engaging portions 30a1 and 30a2 are bent and engaged with the grip portion-side portion to be engaged 31a1. As a result, the cover member 30a is attached to the frame 5aA.

Further, the cover member 30a can also be attached to the yellow developing cartridge 5a by being moved in a direction indicated by an arrow S in FIG. 11(b) and by being engaged with the yellow developing cartridge 5a. That is, by the movement of the cover member 30a in the S direction, engaging portion base portions 30a5, 30a6, 30a7 and 30a8 of the engaging portions 30a1, 30a2, 30a3 and 30a4 of the cover member 30a are bent. Then, the engaging portions 30a1 and 30a2 of the cover member 30a are engaged with the grip portion-side portion to be engaged 31a1, and the engaging portions 30a3 and 30a4 of the cover member 30a is engaged with the container-side portion to be engaged 7a4.

In this embodiment, the mounting and dismounting of the cover member 30a with respect to the yellow developing cartridge 5a in the state in which the yellow developing cartridge 5a is placed on the table 111 so that the disposing surface 7a5 contacts the mounting surface 111A is described. However, the mounting and dismounting of the cover member 30a with respect to the yellow developing cartridge 5a can also be effected in one hand while holding the yellow developing cartridge 5a in the other hand.

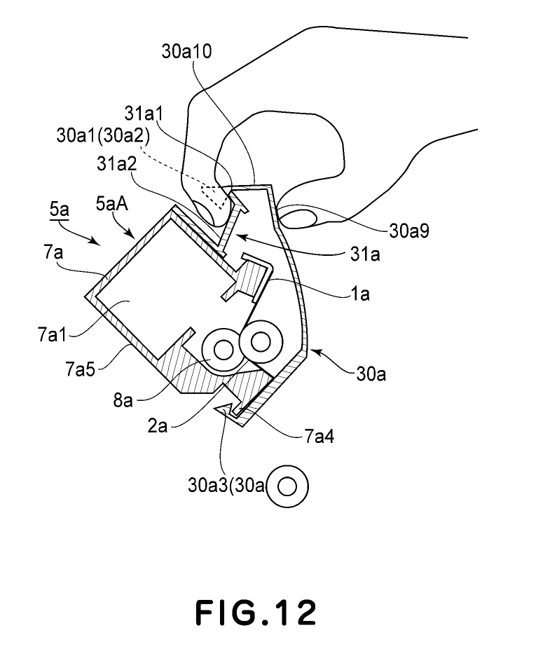

FIG. 12 is a sectional view of the yellow developing cartridge 5a covered with the cover member 30a as seen in a direction perpendicular to the longitudinal direction passing through the grip portion 31a provided in the neighborhood of the longitudinal central portion of the yellow developing cartridge 5a.

In the yellow developing cartridge 5a having a small rotary constitution as in this embodiment, the grip portion 31a and the developing roller 2a protected by the cover member 30a are disposed close to each other. In such a constitution, when the cover member 30a for protecting the developing roller 2a is provided, the grip portion 31a itself is covered with the cover member 30a, so that it is difficult to grip only the grip portion 31a in some cases.

In this embodiment, as shown in FIG. 12, the cover member 30a also has the function as the grip portion 31a. The cover member 30a is provided with a cover member grip surface 30a9 and in the state in which the yellow developing cartridge 5a is covered with the cover member 30a, the user can grip a grip portion grip surface 31a2 and the cover member grip surface 30a9 together, so that the grip portion for the yellow developing cartridge 5a is formed.

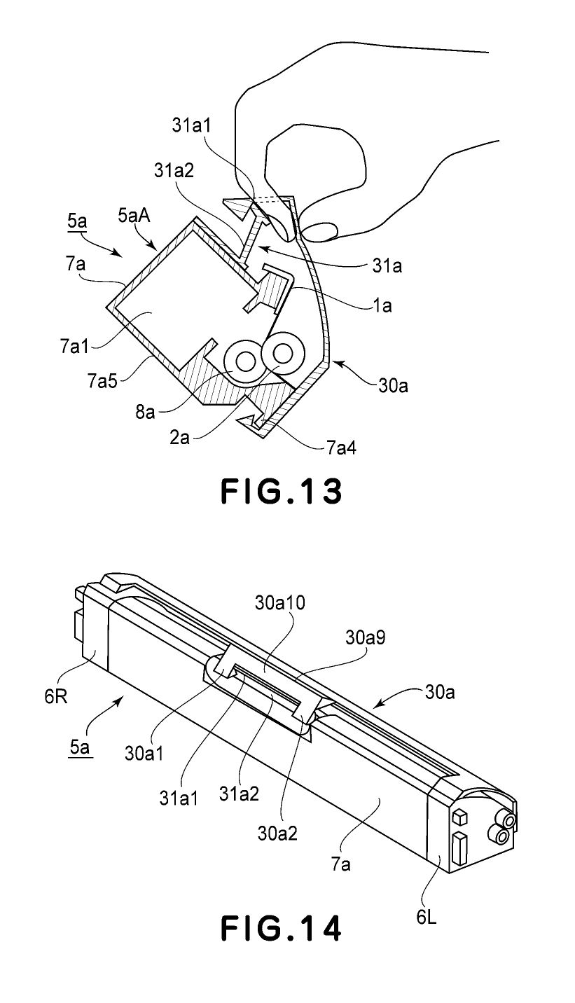

As a result, e.g., as shown in FIG. 13, an adverse effect in the case where only the cover member 30a is gripped is eliminated. That is, drop of the yellow developing cartridge 5a caused by disengagement between the yellow developing cartridge 5a and the cover member 30a when the user grips only the cover member 30a is prevented. Further, in order to prevent the detaching of the cover member 30a from the yellow developing cartridge 5a, there is no need to increase a mounting and dismounting force caused in the case where an engaging force of the engaging portions is strengthened. Therefore, usability is improved according to this constitution.

Further, as shown in FIG. 14, a cover surface 30a10 is provided between the grip portion grip surface 31a2 and the cover member grip surface 30a9 which form the grip portion in the case where the yellow developing cartridge 5a is held. This cover surface 30a10 extends to a position close to the grip portion-side portion to be engaged 31a1 to prevent fingers to enter a gap between the grip portion grip surface 31a2 and the cover member grip surface 30a9. As a result, the user can easily grip the cover member 30a and the grip portion 31a together.

As described above, the engaging portions of the cover member 30a detachably mountable to the yellow developing cartridge 5a are concentrated at a position in the neighborhood of the grip portion 31a for operating the yellow developing cartridge 5a, so that the user's operation can be concentrated at the grip portion 31a. As a result, the mounting and dismounting operation by one hand can be effected. Further, the operating portion and the grip portion are configured as a single portion, thus being easily recognized by the user, so that it is possible to provide the yellow developing cartridge 5a provided with the cover member 30a having good usability. This is also true for other developing cartridges 5b for magenta, 5c for cyan, and 5d for black.

Further, in this embodiment, the case of the color developing cartridges used in the rotary type electrophotographic image forming apparatus is described but the present invention is not limited thereto. For example, the present invention is also applicable to the developing cartridges or a monochromatic developing cartridge in the case of an in-like type image forming apparatus.

While the invention has been described with reference to the structures disclosed herein, it is not confined to the details set forth and this application is intended to cover such modifications or changes as may come within the purpose of the improvements or the scope of the following claims.

This application claims priority from Japanese Patent Applications Nos. 250619/2009 filed Oct. 30, 2009, and 250706/2009 filed Oct. 30, 2010, which are hereby incorporated by reference.

What is claimed is:

1. A developing cartridge detachably mountable to a main assembly of an image forming apparatus, said developing cartridge comprising:
a frame;
a developer carrying member, provided on said frame, for carrying a developer for developing an electrostatic image;
a first portion to be engaged provided on one side of said frame with respect to a direction crossing an axial direction of said developer carrying member;
a second portion to be engaged provided on the other side of said frame with respect to the direction crossing the axial direction of said developer carrying member; and
a cover member, including a first engaging portion engaging with said first portion to be engaged and including a second engaging portion engaging with said second portion to be engaged, for covering an exposed portion of said developer carrying member by being detachably mounted to said frame,
wherein said cover member is detachably mountable to said frame by engaging the first engaging portion with second portion to be engaged and by engaging the second engaging portion with said first portion to be engaged.

2. A cartridge according to claim 1, further comprising a grip portion provided on said frame,
wherein said first portion to be engaged is provided on said grip portion.

3. A cartridge according to claim 2, wherein when a plurality of developing cartridges is mounted in the main assembly of the image forming apparatus, said second portion to be engaged is provided at a position in which it opposes a grip portion provided on an adjacent developing cartridge.

4. A cartridge according to claim 1, wherein said cover member is configured so as not to contact the exposed portion of said developer carrying member in both of a first state in which the first engaging portion engages with said first portion to be engaged and the second engaging portion engages with said second portion to be engaged and a second state in which the first engaging portion engages with said second portion to be engaged and the second engages with said first portion to be engaged.

5. A cartridge according to claim 1, wherein in the case where said cover member is mounted to said frame in a state in which the first engaging portion engages with said first portion to be engaged and the second engaging portion engages with said second portion to be engaged, said cover member is configured, when being dismounted from said frame, to release the engagement of the second engaging portion after the engagement of the first engaging portion is released and then said cover member is rotated about the second engaging portion.

6. A cartridge according to claim 5, wherein said first portion to be engaged is positioned above said second portion to be engaged in a state in which said developing cartridge is disposed so that its disposing surface opposes a mounting surface on which said developing cartridge is to be mounted.

7. A cartridge according to claim 6, wherein the second engaging portion includes a claw portion having a height which is smaller than a distance from the mounting surface to said second portion to be engaged.

8. A cartridge according to claim 1, wherein said first portion to be engaged and said second portion to be engaged are provided at positions in which at least a part of said first portion to be engaged overlaps with a part of said second portion to be engaged with respect to a direction perpendicular to the axial direction of said developer carrying member.
